(19) United States
(12) Patent Application Publication
(10) Pub. No.: US 2011/0252447 A1
(43) Pub. Date: Oct. 13, 2011

(54) PROGRAM INFORMATION DISPLAY APPARATUS AND METHOD

(75) Inventors: Masaru Suzuki, Kawasaki-shi (JP); Isao Mihara, Tokyo (JP); Masahiro Sekine, Fuchu-shi (JP)

(73) Assignee: KABUSHIKI KAISHA TOSHIBA

(21) Appl. No.: 13/110,279

(22) Filed: May 18, 2011

Related U.S. Application Data
(63) Continuation of application No. PCT/JP2009/069576, filed on Nov. 18, 2009.

(30) Foreign Application Priority Data
Nov. 19, 2008 (JP) 2008-295849

(51) Int. Cl. H04N 5/445

(52) U.S. Cl. 725/41

(57) ABSTRACT

According to one embodiment, a program information display apparatus includes a first reading unit, a first extraction unit, a second reading unit, a second extraction unit, a first accumulation unit and a first control unit. The first reading unit is configured to read first program information items including bibliographic information items and program accompanying information items. The first extraction unit is configured to extract first program attribute information items indicating first program attributes for each of the programs. The second reading unit is configured to read video data from an external video data database. The second extraction unit is configured to extract thumbnail images from the video data. The first accumulation unit is configured to accumulate the thumbnail images associated with the first program attributes. The first control unit is configured to control a display of first thumbnails and the first program information items related to the first thumbnails.

### CROSS-REFERENCE TO RELATED APPLICATIONS

This is a Continuation Application of PCT Application No. PCT/JP2009/069576, filed Nov. 18, 2009, which was published under PCT Article 21(2) in Japanese.

This application is based upon and claims the benefit of priority from Japanese Patent Application No. 2008-295849, filed Nov. 19, 2008; the entire contents of which are incorporated herein by reference.

### FIELD

Embodiments described herein relate generally to a program information display apparatus and method.

### BACKGROUND

With the popularization of an electronic program guide (EPG), the technique for displaying a conventional television guide or the like used in paper (e.g. a newspaper) on the screen of a television or a personal computer and scheduling program recording has been widely used. In addition, with the popularization of a hard disk drive (HDD) recorder and the like, a large number of television programs have come to be recorded even at home. These types of devices provide a screen that enables the user to list recorded programs and select a program the user wants to watch. Such a screen enables the user to select a program more intuitively by displaying a cut of still image in a program as thumbnail forms together with textual information, such as a program title(See, e.g., JP-A. No. 2008-4985(KOKAI)).

### BRIEF DESCRIPTION OF THE DRAWINGS

FIG. 1 is a block diagram of a program information display apparatus according to a first embodiment;

FIG. 2 is a flowchart illustrating the operation of an attribute information extraction unit;

FIG. 3 shows an example of program information items;

FIG. 4 shows an example of attribute information items in past;

FIG. 5 is a flowchart to explain the operation of a thumbnail extraction unit;

FIG. 6 shows an example of a thumbnail;

FIG. 7 shows an example of data accumulated in a thumbnail accumulation unit;

FIG. 8 is a flowchart illustrating the operation of a thumbnail selection unit;

FIG. 9 shows an example of attribute information items in future;

FIG. 10 shows an example of a display of a program guide;

FIG. 11 shows another example of a display of a program guide;

FIG. 12 is a block diagram of a program information display apparatus according to a second embodiment; and

FIG. 13 shows an example of a display of a program guide according to the second embodiment.

### DETAILED DESCRIPTION

In general, according to one embodiment, a program information display apparatus includes a first reading unit, a first extraction unit, a second reading unit, a second extraction unit, a first accumulation unit and a first control unit. The first reading unit is configured to read, from an external program information database, first program information items including bibliographic information items on programs and program accompanying information items on the programs. The first extraction unit is configured to extract, from the first program information items for each of the programs, first program attribute information items indicating first program attributes. The second reading unit is configured to read video data from an external video data database if the external video data database has the video data corresponding to at least one of the first program information items. The second extraction unit is configured to extract thumbnail images from the video data if there is the thumbnail images corresponding to each of the first program attributes at a given time of the video data. The first accumulation unit is configured to accumulate the thumbnail images associated with each of the first program attributes. The first control unit is configured to control a display of first thumbnails and the first program information items related to the first thumbnails, each of the first thumbnails being the thumbnail images corresponding to each of the first program attributes.

In the following, the program information display apparatus and method according to the present embodiment will be described in details with reference to the drawings. In the embodiment described below, the same reference numerals will be used to denote similar-operation elements, and a repetitive description of such elements will be omitted.

### First Embodiment

A first embodiment may be realized in the form of software that displays electronic program guide information on a video recording and reproducing device, such as a television or a video recorder, or in the form of a device in which the software has been installed.

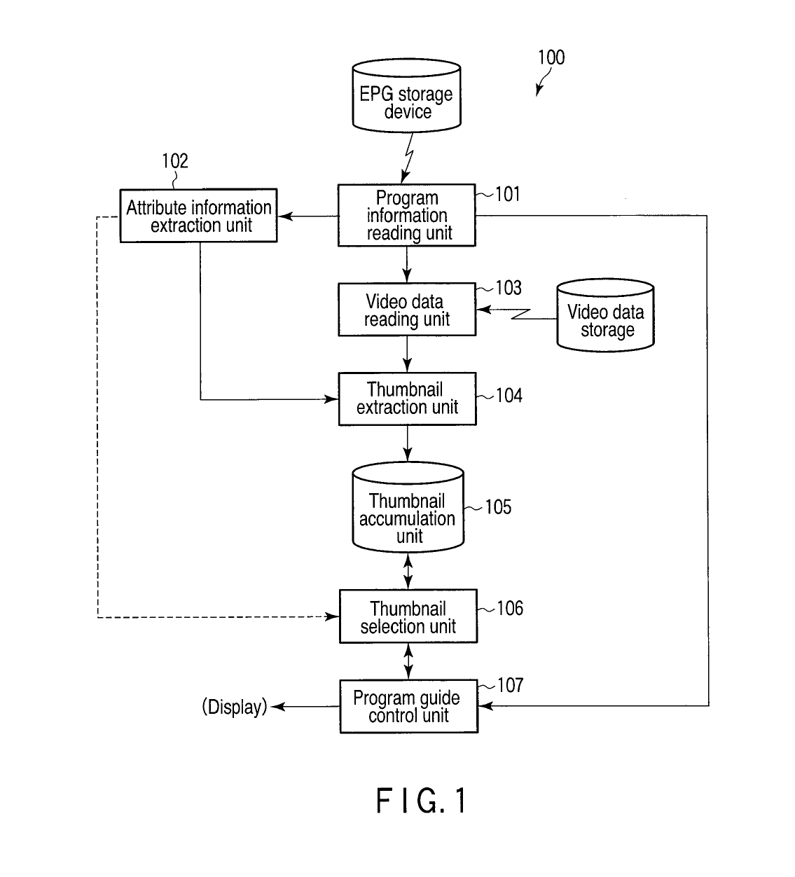

A program information display apparatus and method according to the embodiment will be explained with reference to FIG. 1.

A program information display apparatus 100 according to first embodiment includes a program information reading unit 101, an attribute information extraction unit 102, a video data reading unit 103, a thumbnail extraction unit 104, a thumbnail accumulation unit 105, a thumbnail selection unit 106, and a program guide control unit 107.

The program information reading unit 101 receives the input of program information items include bibliographic information items on individual programs included in an electronic program guide (EPG) and closed caption (program accompanying information) from EPG storage device or the like outside the embodiment and sends the program information items to the attribute information extraction unit 102, video data reading unit 103, and program guide control unit 107. Bibliographic information is information that indicates the details of a program including the broadcasting station, broadcast date and time, title, and genre of the program. Program accompanying information is information that indicates the details of broadcast contents, including actual conversation on the air and textual information in a telop. Program accompanying information is, for example, caption information, speech recognition result, and telop recognition result. In addition, program information items on programs to be broadcast in future may be input sequentially to the program information reading unit 101. Moreover, program information items on programs the user is now viewing or recording may be input to the program information reading unit 101. Since a future program has not included a closed caption yet, program information items is composed of only bibliographic information items on the program. A program the user is now viewing or recording includes bibliographic information items on the program and a closed caption. If a program the user is now viewing or recording includes no closed caption, its program information items is composed of only bibliographic information items on the program.

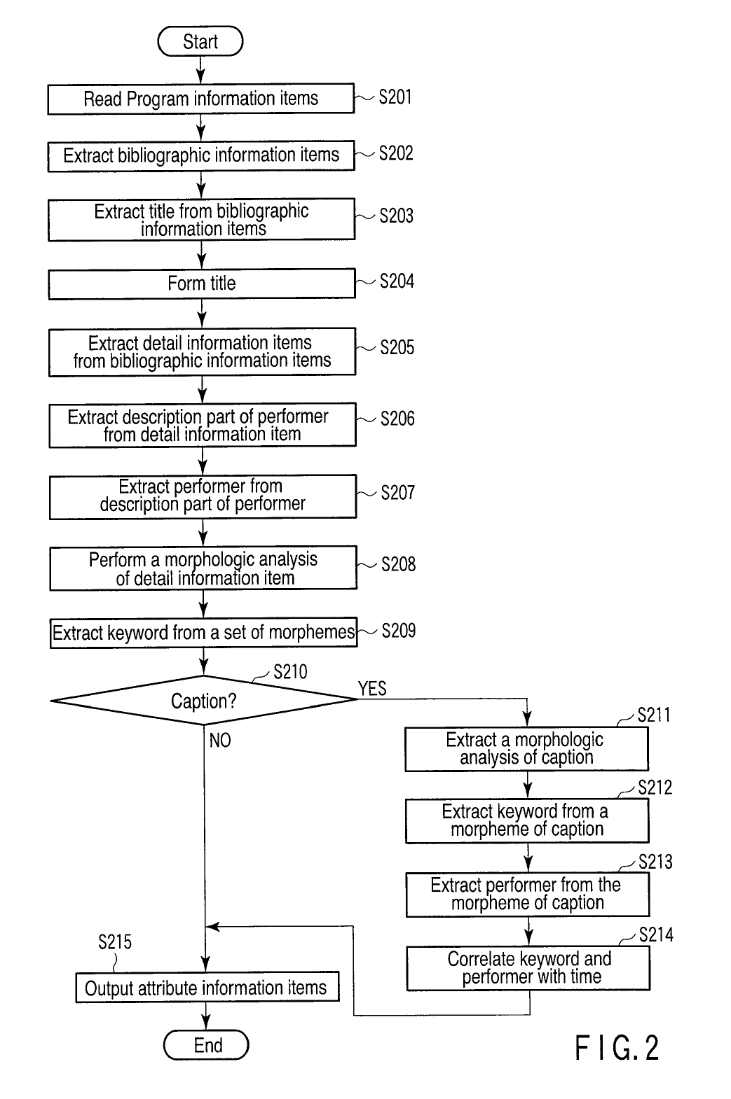

The attribute information extraction unit 102 receives the input of program information items from the program information reading unit 101, extracts attribute information items from the program information items, and sends the attribute information items to the thumbnail extraction unit 104. The attribute information items indicate classifications related to programs, for example, such as program title, performer, keyword, and genre. In the case of a program to be broadcast in future, attribute information items are further sent to the thumbnail selection unit 106. The operation of the attribute information extraction unit 102 will be explained in detail later with reference to FIGS. 2, 3, and 4.

When program information items received from the program information reading unit 101 is a program the user is now viewing or recording, the video data reading unit 103 reads image data on the program from an external video data storage, such as a television or a video recorder, and sends the video data to the thumbnail extraction unit 104. The video data is related to time and video information, but not the essentials of the embodiment and therefore a concrete example will not be explained in detail.

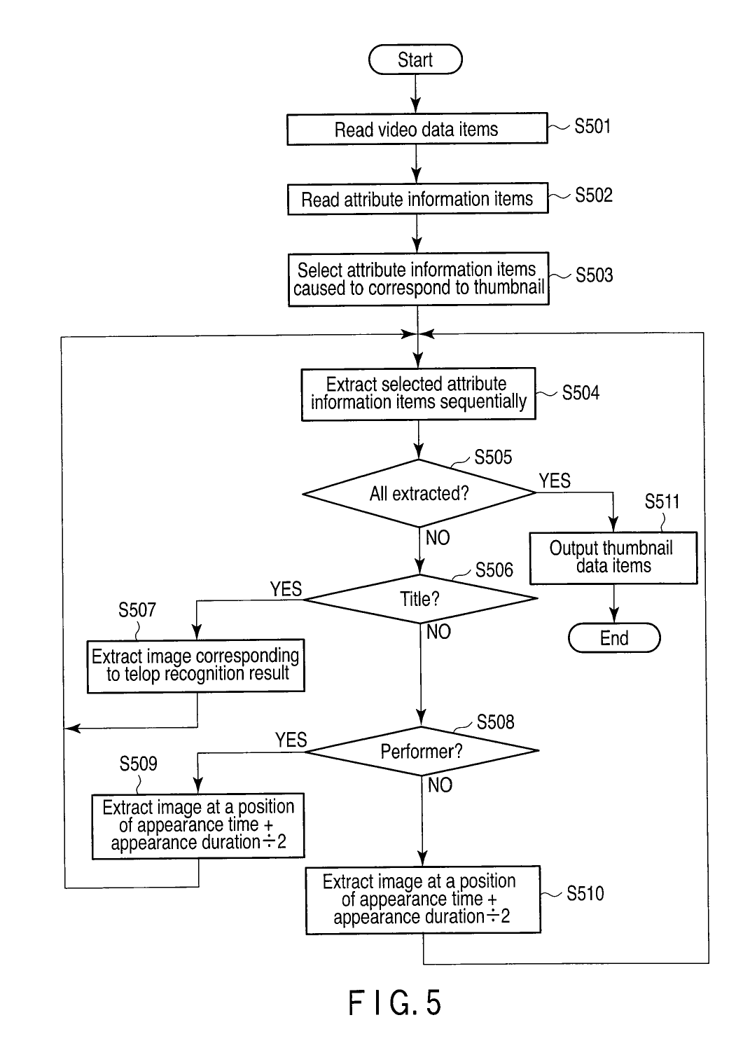

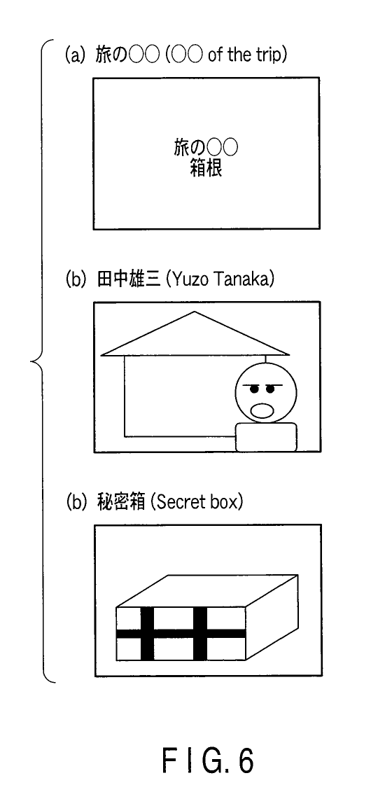

The thumbnail extraction unit 104 receives attribute information items from the attribute information extraction unit 102 and video data from the video data reading unit 103, and extracts corresponding suitable images in the form of one or more than one thumbnail, while referring to each attribute information items. A thumbnail (or thumbnail image) indicates an image of video data at a given time. The operation of the thumbnail extraction unit 104 will be explained in detail later with reference to FIGS. 5 and 6.

The thumbnail accumulation unit 105 receives attribute information items and a thumbnail related to the attribute information items from the thumbnail extraction unit 104 and accumulates these in such a manner that they are related to corresponding attribute information items.

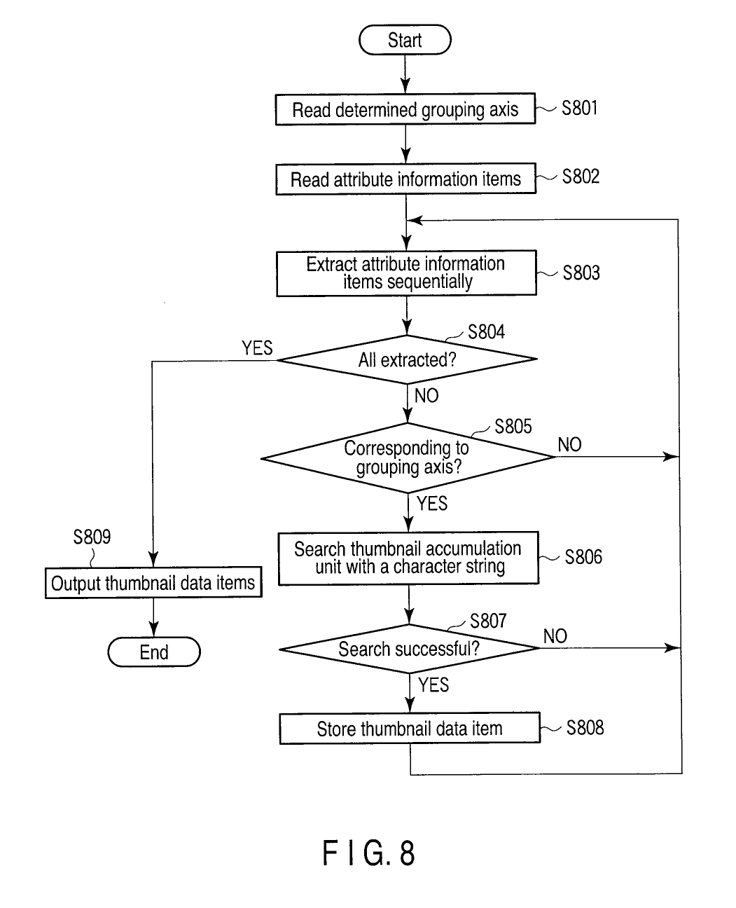

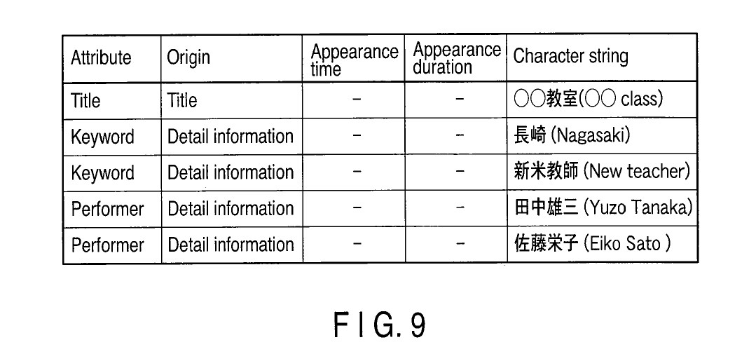

In the case of a program the user is now viewing or recording, the thumbnail selection unit 106 receives attribute information items and a thumbnail related to the attribute information items from the thumbnail accumulation unit 105 and sends them to the program guide control unit 107. In the case of a program to be broadcast in future, the thumbnail selection unit 106 selects a thumbnail suited to be displayed as a thumbnail of a program from the thumbnail accumulation unit 105, referring to the attribute information items extracted from program information items by the attribute information extraction unit 102. The operation of the thumbnail selection unit 106 will be explained in detail later with reference to FIGS. 8 and 9.

In the case of a program the user is now viewing or recording, the program guide control unit 107 receives program information items from the program information reading unit 101 and attribute information items and a suitable thumbnail from thumbnail selection unit 106 and outputs these in the form of a program guide to an external display device or the like, thereby controlling a display or the like on the screen or the like. In the case of a program to be broadcast in future, the program guide control unit 107 combines program information items on a program that is to be broadcast in future from the program information reading unit 101 and a thumbnail that extracted by the thumbnail selection unit 106 to produce a program guide, sends the program guide to an external display device, and displays the program guide on an external display device. The displayed program guide can be used for the user to select a program to view or to select a program to record.

<Operation of Attribute Information Extraction Unit>

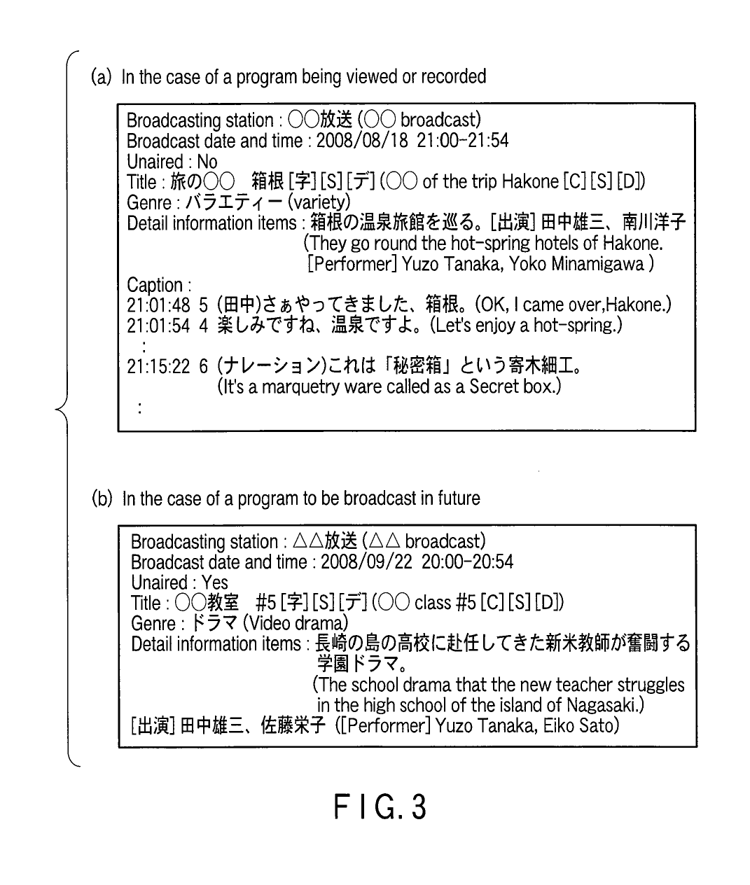

The operation of the attribute information extraction unit 102 will be explained in detail with reference to a flowchart in FIG. 2 and a figure in FIG. 3.

First, the attribute information extraction unit 102 reads program information items from the information reading unit 101 (S201). FIG. 3 shows an example of the read program information items. FIG. 3 (a) shows an example of program information items on a program the user is now viewing or recording. FIG. 3 (b) shows an example of program information items on a program to be broadcast in future wherein program accompanying information has not been acquired yet. Here, consider a case where program information items as shown in FIG. 3 (a) is input to the program information reading unit 101.

Next, the attribute information extraction unit 102 extracts bibliographic information items from the read program information items (S202). What are extracted as bibliographic information items are the following items: broadcasting station, broadcast date and time, unaired (flag), title, genre, and detail information item. In particular, the following items of information are extracted: “◯◯ [symbol] (OO Television)” as broadcasting station, “2008/08/18 21:00-21:54” as broadcast date and time, “No” as unaired, “ [symbol] ◯◯ [symbol] [ [symbol] ] [S] [ [symbol] ](◯◯ of the trip Hakone [C] [S] [D])” as title, “ [symbol] —(Variety)” as genre, and “ [symbol] [symbol] [ [symbol] ] [symbol] , [symbol] (They go round the hot-spring hotels of Hakone. [Performer] Yuzo Tanaka, Yoko Minamigawa)” as detail information item. Herein, “Hakone” is one of the most popular hot-spring resorts in Japan. “Yuzo Tanaka” and “Yoko Minamigawa” are personal names.

Next, the title is extracted from the bibliographic information items extracted in S202 (S203). Here, “ [symbol] ◯◯ [symbol] [ [symbol] ][S] [ [symbol] ]” is extracted as the title. Suppose the character string “◯◯” in the example of FIG. 3 (a) is actually a word composed of, for example, two kanji characters.

Since the extracted title may include symbols indicating types of broadcasting unrelated to the original program, those symbols are removed (S204). Here, “[C]” (indicating closed-captioned broadcasting), “[S]” (indicating stereo broadcasting), “[D]” (indicating digital broadcasting) correspond to symbols to be removed. The removal process can be realized by searching, for example, the beginning of the title for a character string, such as “[” or “(”, and removing the character strings after either symbol appears for the first time. Since character strings indicating broadcast numbers may be included in the title as the symbols indicating the types of broadcasting are, these are also removed in S204. For example, in the example of FIG. 2 (b), “◯◯ [symbol] #5 [ [symbol] ] [S] [ [symbol] ] (OO class #5 [C] [S] [D])” is extracted as the title. In the title, “#5” indicates a broadcast number. The process of removing the broadcast number can be realized by searching for a character string pattern of, for example, “# +number string” or “ [symbol] +number string+ [symbol] ” and removing the broadcast string pattern. By the above process, the extracted title is formed into ““ [symbol] ◯◯ [symbol] ”. Next, the detail information item is extracted from the bibliographic information items extracted in S202 (S205). The extracted detail information item is “ [symbol] [symbol] ∘ [ [symbol] ] [symbol] , [symbol] ”.

Then, a description part of a performer is cut out of the detail information item (S206). This process can be realized by searching for a character string pattern of, for example, “left parenthesis+ [symbol] (Performer)+right parenthesis”, “left parenthesis+ [symbol] (Reporter)+right parenthesis”, “left parenthesis+ [symbol] (Moderator) +right parenthesis”, or “left parenthesis+Performer+right parenthesis”, and extracting the character strings following the right end of the searched positions. Since these character patterns may appear a plurality of times, the extracted character string must be processed recursively. In this case, the cut-out performer part is [symbol] , [symbol] [symbol] ”.

Then, the names of performers are extracted from the cut-out the description part of the performer (S207). This process can be realized by dividing the description part of a performer by delimiters, including “,”, “,”, “/”. Therefore, the names of performers finally extracted are “ [symbol] ” and “ [symbol] ”.

Next, a morphologic analysis of the detail information item extracted in S205 is performed by a known method (S208) and a keyword is extracted from a set of processed morphemes (S209). At this time, the description part of the performer cut out in S206 is set as an object not to be processed. In particular, the result of the morphologic analysis is, for example, In Japanese, “ [symbol] <proper noun (place name)>+ [symbol] <particle>+ [symbol] <noun>+ [symbol] <noun>+ [symbol] <particle>+ [symbol] <verb>+∘<punctuation mark>”. As the same manner in English, “They<noun>+go . . . round<idiom>+the<article>+hot-spring<noun>+hotels<noun>+of<preposition>+Hakone<proper noun>”. A keyword can be extracted from the set of morphemes by, for example, a method of extracting “proper noun” or “phrase where two or more nouns are successive”. In this example, “ [symbol] ”, [symbol] ” are extracted as keywords.

In S210, the attribute information extraction unit 102 determinates whether or not the program information items include a caption. If the program information items include a caption, the operation proceeds to S211. If the program information items include no caption, the operation proceeds to S215, and the attribute information extraction unit 102 controls to output the attribute information items. The attribute information extraction unit 102 makes a morphologic analysis of program accompanying information (S211) and extracts keywords from the morpheme string (S212). This extraction process is the same as that in S208 and S209 and therefore will not be explained in detail. In this case, keywords extracted in S212 are “ [symbol] ”, “ [symbol] (Secret box)”, “ [symbol] (marquetry ware)”.

Next, performers are extracted from the morpheme string in the caption (S213). This can be realized by searching for places where the names of the performers extracted in S207 appear in the caption. Since only the family names of the performers may be written in the caption as shown FIG. 3(a), it is necessary to search for partial character strings of the names of performers. The name of a performer searched for with a partial character string (e.g., “ [symbol] ”) is restored to the full name (e.g., “ [symbol] ”).

Furthermore, the keywords and the names of performers extracted in S212 and S213 are related to time information in the caption in which they appeared (S214).

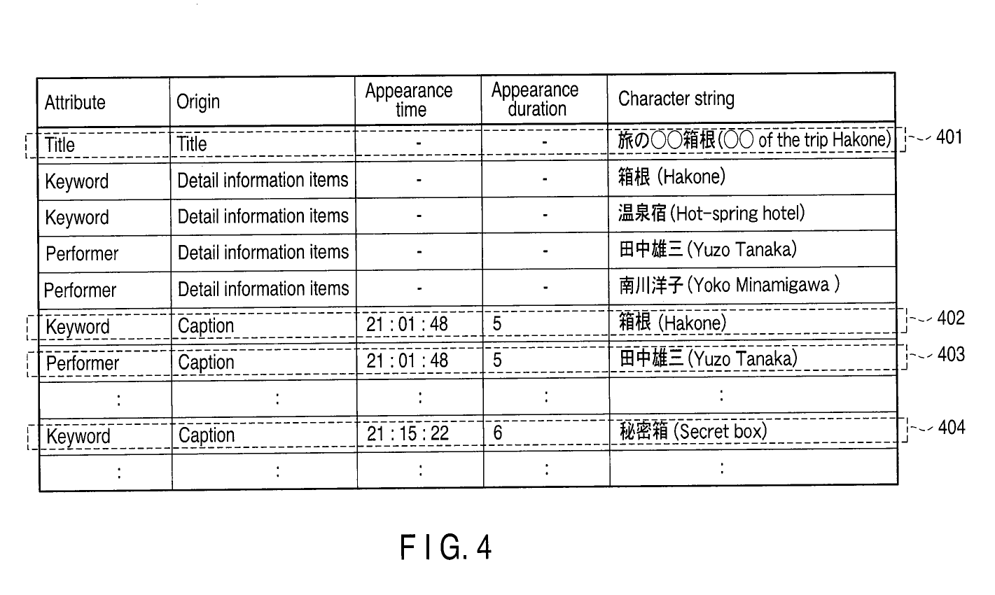

The title, keywords, and performers' names obtained by the above process are output as attribute information items (S215), which completes the operation of the attribute information extraction unit 102. FIG. 4 shows a concrete example of attribute information items extracted from the program information items of FIG. 3(a). For purposes of illustration, FIG. 4 shows only a part of the attribute information items. The attribute information extraction unit 102 stores individual attributes in such a manner that items of information, including origin, appearance time, appearance duration, and character string, are related to the attributes as shown by title 401, keyword 402, performer 403, keyword 404.

<Operation of Thumbnail Extraction Unit>

Next, the operation of the thumbnail extraction unit 104 will be explained in detail with reference to a flowchart in FIG. 5.

First, the thumbnail extraction unit 104 reads video data from the video data reading unit 103 (S501). Then, the thumbnail extraction unit 104 reads attribute information items from the attribute information extraction unit 102 (S502). Here, consider the example of attribute information items in FIG. 4 as a concrete example. A concrete example of video data is not particularly shown because it is not necessary for explanation of the embodiment as described above.

Next, the thumbnail extraction unit 104 selects attribute information items on corresponding thumbnails to be extracted from the read attribute information items (S503). The criteria of selection are (1) Title is selected when the origin is title, (2) Keyword and performer are selected when the origin is caption, (3) The priority of an item which has the same attributes at the same appearance time is lowered when there are a plurality of items corresponding to the same character string in (2). Criterion (3) is for lowering the probability of a decrease in the distinction because the distinction between thumbnails is deteriorated if a plurality of things (e.g., a plurality of performers) are included in one cut. In the example of FIGS. 4, 401 to 404 are selected. For simplicity, only a part of the selected items are shown.

Next, the selected attribute information items are extracted sequentially (S504). In S505, if all the selected attribute information items have been extracted, the operation proceeds to S511. If not, the operation repeats the processes S506 to S510 described below.

In S506, if the extracted attribute is title, the operation proceeds to S507. In S507, the thumbnail extraction unit 104 processes video data by known telop recognition techniques, searches for an image whose recognition result includes a character string of the title (in this case, “ [symbol] ◯◯ [symbol] ”), extracts the image in the form of a thumbnail, and the operation returns to S504. Since the title may have been divided into a plurality of cuts, a leading character string (in this case, “ [symbol] ◯◯”) obtained by dividing the character string of the title by a delimiter, such as a blank character, may be searched for. In addition, since the telop recognition result may include a recognition error, the result may be collated with the character string of the title by partial match using, for example, an edit distance of the character string. If the extracted attribute is not title, the operation proceeds to S508.

In S508, if the extracted attribute is performer, the operation proceeds to S509. In S509, the thumbnail extraction unit 104 calculates a time of “appearance time+appearance duration÷2” by using the appearance time and appearance duration (duration time displaying the caption) in the caption of attribute items, extracts a cut in video data corresponding to the calculated time in the form of a thumbnail, and the operation returns to S504. While in the embodiment, the thumbnail extraction unit 104 has searched for the thumbnail of the person from the video data using the performer's name in the caption as a clue, the thumbnail extraction unit 104 may use, for example, a method of searching the video data for an image of a performer included in bibliographic information items by using known person's face detection techniques.

If the extracted attribute is neither title nor performer, there should be another attribute information item, such as keyword or genre. Therefore, the thumbnail extraction unit 104 calculates a time of “appearance time+appearance duration÷2” by using the appearance time and appearance duration (duration time displaying the caption) in the caption of attribute items and extracts a cut in video data corresponding to the calculated time in the form of a thumbnail (S510).

After in S506 to 510, having processed all the attribute items selected in S503, the operation proceeds from S505 to S511 and outputs data on the extracted thumbnails to the thumbnail accumulation unit 105. According to the process described above, the operation of the thumbnail extraction unit 104 is finished. An example of the extracted thumbnails is shown in FIG. 6. For simplicity, only a part of the extracted thumbnails are shown.

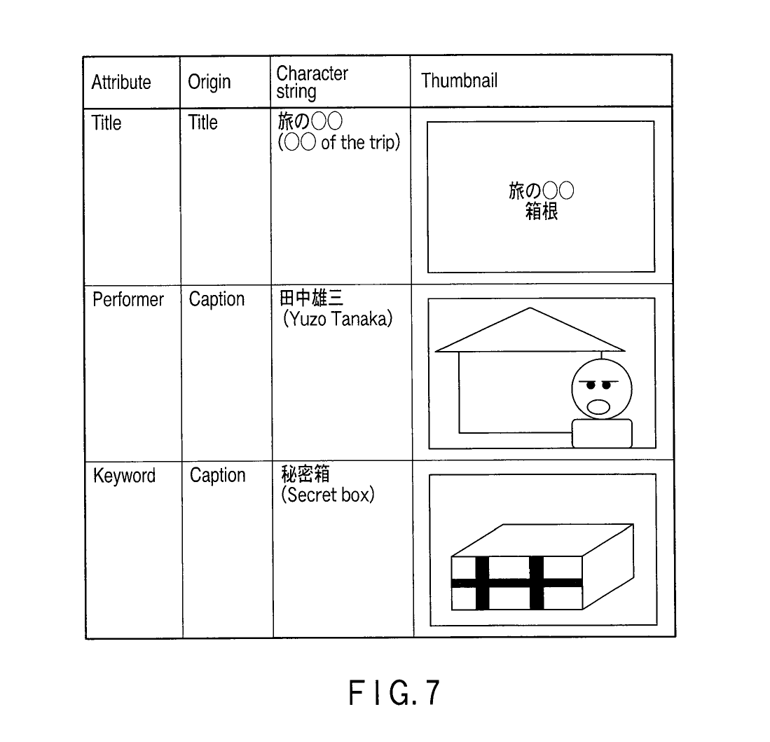

FIG. 7 shows an example of data when the thumbnails of FIG. 6 are accumulated in the thumbnail accumulation unit 105. In this way, thumbnails corresponding to attribute information items (in this case, attribute, origin, character string) are stored. This process can be performed immediately after, for example, the user has viewed or recorded a program. Alternatively, the process can be performed in the background while the user is viewing or recording a program. Data item on a thumbnail is accumulated in the thumbnail accumulation unit 105 each time the process is performed.

<Process Performed on Unaired Programs>

As described above, the thumbnail of a program the user is now viewing or recording can be acquired easily from the thumbnail accumulation unit 105. A thumbnail of an unaired program to be broadcast in future has not been obtained yet. The process of assigning thumbnails to program information items on unaired programs and displaying the resulting program information items in the form of a program guide will be explained with reference to a flowchart of the operation of the thumbnail selection unit 106 in FIG. 8.

First, a grouping axis determined by the user is read (S801). The grouping axis is a determined attribute by determining which the attributes (including title, performer, keyword, and genre etc.) is used as a thumbnail of the program attribute. In some embodiments, a screen for the user to determine which of title, performer, and keyword is used as a grouping axis of program guide display may be presented and may prompt the user to select a grouping axis. The grouping axis can be changed with arbitrary timing. In addition, if the user does not particularly specify a grouping axis, a predetermined grouping axis, for example, performer may be used as a grouping axis.

Next, the thumbnail selection unit 106 reads the attribute information items extracted by the attribute information extraction unit 102 (S802). In particular, FIG. 9 is assumed to be read as attribute information items on an unaired program. The attribute information items shown in FIG. 9 have been extracted from FIG. 3(b) showing program information items on an unaired program.

Next, in S803, the thumbnail selection unit 106 extracts the attribute information item that read by the thumbnail selection unit 106 sequentially, and carries out the processes in S805 to S808 repeatedly until the thumbnail selection unit 106 has extracted all the items.

In S805, if the read attribute information item correspond with the grouping axis read in S801, the thumbnail selection unit 106 searches the thumbnail accumulation unit 105 with the value of a character string of the attribute information items (S806). If the read attribute information item does not correspond with the grouping axis, the operation returns to S803 and the thumbnail selection unit 106 extracts the next attribute information item. The thumbnail accumulation unit 105 can be searched by known character string searching techniques and therefore will not be explained in detail.

In FIG. 8, all the thumbnails searched for are stored in S808 when a plurality of thumbnails have been searched with respect to one attribute information item. Instead of collecting a plurality of thumbnails, for example, a more suitable thumbnail may be selected from the thumbnails searched for according to the targeted type of attribute information items. For example, if the targeted grouping axis is “title”, a thumbnail with the latest entry date may be given highest priority among the thumbnails searched for. If the targeted grouping axis is “performer”, thumbnails extracted from programs with the same title may be given high priority. To perform such an operation, information on entry date and information on the title of a program from which thumbnails have been extracted can be given in advance to data (FIG. 7) accumulated in the thumbnail accumulation unit 105.

Next, if searching the thumbnail accumulation unit 105 has been successful (S807), the thumbnail selection unit 106 stores the searched thumbnail data items (S808) and the operation returns to S803. If searching the thumbnail accumulation unit 105 has not been successful, the operation returns to S803 and the thumbnail selection unit 106 extracts the next attribute information item. After having performed the processes in S805 to S808 for all the attribute items in S804, the thumbnail selection unit 106 outputs the stored thumbnail data items as the selection result to the program guide control unit 107 (S809) and completes the operation of the thumbnail selection unit 106. Here, suppose the thumbnail shown in FIG. 6(b) has been selected.

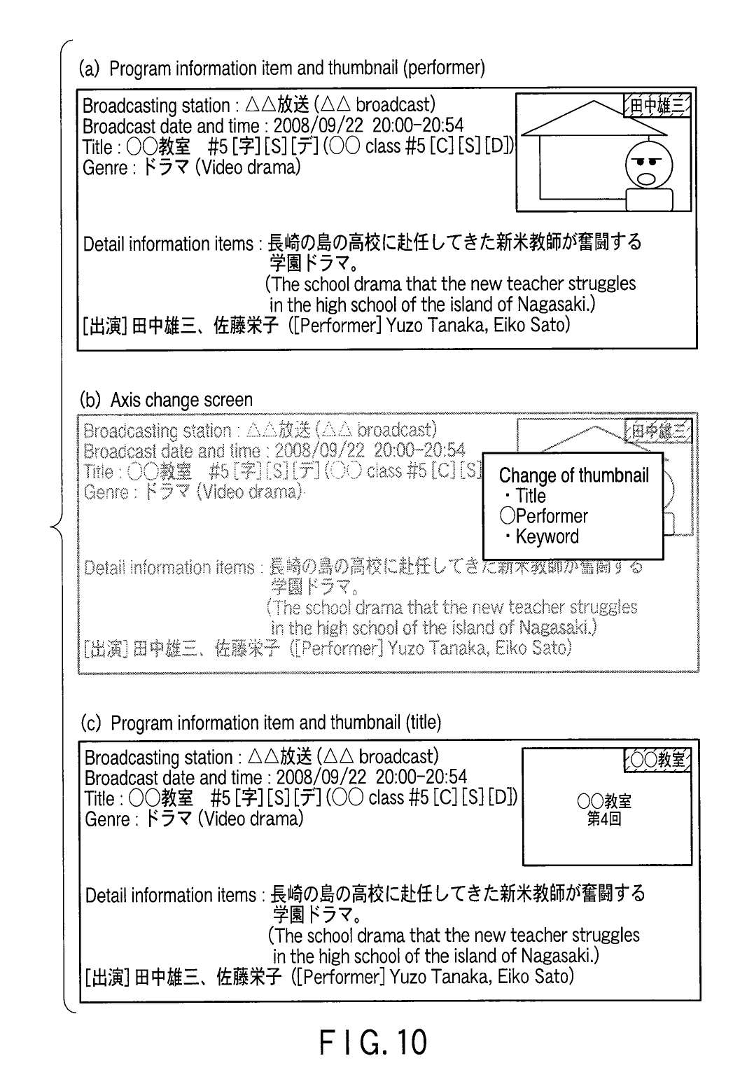

FIG. 10 shows an example of the screen of a program guide displayed by the program guide control unit 107 which receives a thumbnail from the thumbnail selection unit 106 as a result of the above process. When the thumbnail selection unit 106 has output a plurality of thumbnails, the program guide control unit 107 may display only an arbitrary thumbnail or display a plurality of thumbnails so as to switch between them at specific intervals of time. FIG. 10(a) shows an example of the screen of a program guide when “performer”, a predetermined grouping axis, has been selected.

FIG. 10(b) shows an example of displaying a screen for specifying and changing the grouping axis according to an instruction given by the user on the screen of FIG. 10(a). FIG. 10(c) shows an example of the screen when the user selected “title” as the grouping axis in FIG. 10(b).

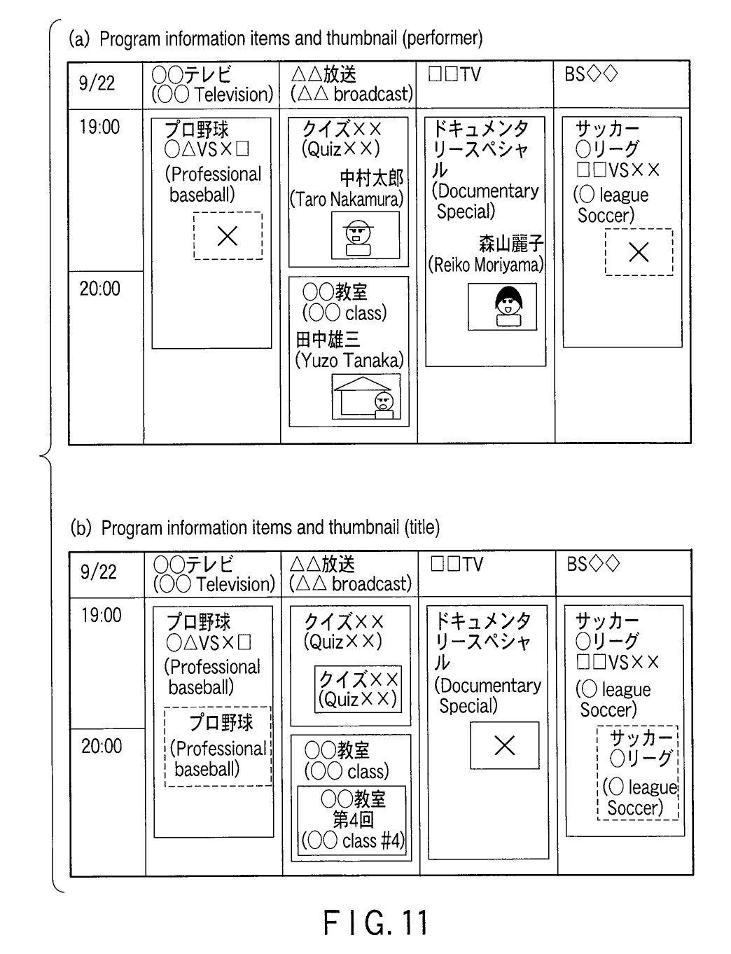

FIG. 10 shows an example of displaying a program guide for one program. For example, program information items on a plurality of programs may be displayed simultaneously by setting broadcast time as a vertical grouping axis and broadcasting station as a horizontal axis. An example of the screen in this case is shown in FIG. 11. FIG. 11(a) shows an example of displaying thumbnails with “performer” as a grouping axis. When a thumbnail cannot be extracted, “x” or the like may be displayed. FIG. 11(b) shows an example of displaying thumbnails with “title” as a grouping axis. As described above, when program information items on a plurality of programs is displayed at a time, program information items on a plurality of programs are input sequentially to the program information reading unit 101. Thereafter, the same processes as in the case of one program are performed sequentially.

According to the first embodiment described above, a program guide shown in FIG. 10 or FIG. 11 can be presented to the user. The user can select a program to view or record, while referring to suitable thumbnail images of unaired programs. Even in the case of unaired programs, thumbnails of related titles, performers, and keywords can be displayed.

### Second Embodiment

In the first embodiment, attention has been focused on displaying only a thumbnail of a target program, for example, a program now being viewed or recorded or an unaired program to be broadcast in future, or displaying a program guide of each broadcasting station. A second embodiment is characterized by selecting programs related to a grouping axis (hereinafter, the selecting programs are also referred to as related programs) and displaying them for an arbitrary target program. A target program means a program the user is going to view. It may be a program that the user is now viewing, a recorded program, or an unaired program. The second embodiment may be realized on a video recording and viewing device, such as a television or a video recorder, in the form of software that displays program information items or a device in which the software has been installed.

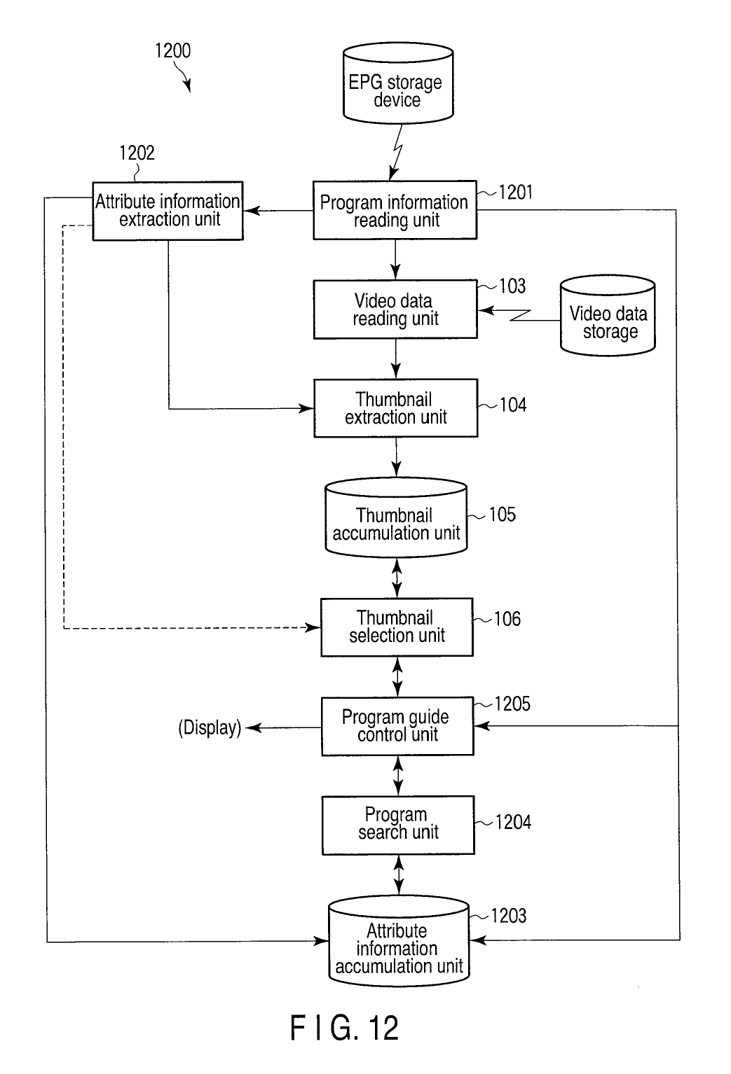

First, a program information display apparatus according to the second embodiment will be explained with reference to FIG. 12.

A program information display apparatus 1200 includes a program information reading unit 1201, an attribute information extraction unit 1202, a video data reading unit 103, a thumbnail extraction unit 104, a thumbnail accumulation unit 105, a thumbnail selection unit 106, an attribute information accumulation unit 1203, a program search unit 1204, and a program guide control unit 1205. Since the video data reading unit 103, thumbnail extraction unit 104, thumbnail storage unit 105, and thumbnail selection unit 106 operate in the same manner as in the first embodiment, an explanation of them will be omitted.

The program information reading unit 1201 operates in almost the same manner as in the first embodiment, but differs from the first embodiment in that the program information reading unit 1201 further sends read program information items to the attribute information accumulation unit 1203.

The attribute information extraction unit 1202 operates in almost the same manner as in the first embodiment, but differs from the first embodiment in that the attribute information extraction unit 1202 further sends extracted attribute information items to the attribute information accumulation unit 1203.

The attribute information accumulation unit 1203 associates program information items read by the program information reading unit 1201 with attribute information items extracted by the attribute information extraction unit 1202, and accumulates those information items. The attribute information extraction unit 1203 sends the accumulated information items to the program search unit 1204.

The program search unit 1204 receives program information items on a target program from the program guide control unit 1205 described later and searches the attribute information accumulation unit 1203 for program information items and attribute information items, which relate to the target program. A search of a related program is performed on the basis of character string matching in terms of each grouping axis, such as title, performer, keyword, or genre. The attribute information accumulation unit 1203 sends, each of the search results which character string has matched with the related program, to the program guide control unit 1205.

The program guide control unit 1205 receives program information items on the target program input by the program information reading unit 1201 and a thumbnail of the target program from the thumbnail selection unit 106, outputs them to an external display device or the like, and controls a display. In addition, the program guide control unit 1205 sends program information items on the target program to the program search unit 1204, receives the result of searching for, program information items on a related program related to the target program and attribute information items from the program search unit 1204. According to the search result, the program guide control unit 1205 selects a thumbnail from the thumbnail selection unit 106 and controls a display of the thumbnail.

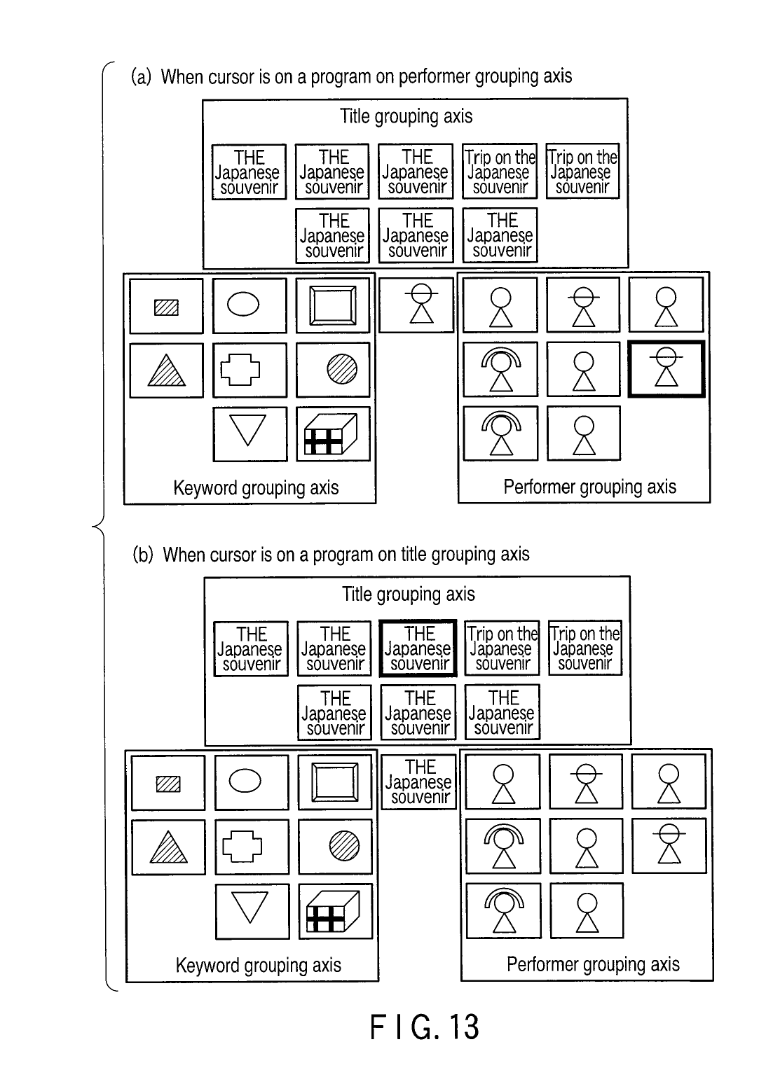

An example of screen display of program information items on a related program will be explained in detail with reference to FIG. 13.

A thumbnail of the targeted image is displayed at the center and thumbnails of a plurality of related programs searched for by the program search unit 1204 are classified into a title grouping axis, a performer grouping axis, and a keyword grouping axis and displayed so as to surround the target image. That is, a thumbnail classified as the title grouping axis displays a thumbnail with the grouping axis of a related program being “title”, a thumbnail classified as the keyword grouping axis displays a thumbnail with the grouping axis of a related program being “keyword”, and a thumbnail classified as the performer grouping axis displays a thumbnail with the grouping axis of a related program being “performer”.

Furthermore, the selection of a thumbnail, the result of the user having searched for a related program, is accepted, thereby causing the thumbnail selection unit 106 to change the selection of program information items and the thumbnail on the target program according to the grouping axis of the selected related program. Then, the program guide control unit 1205 controls a display of the selected thumbnail on the program guide. For example, in FIG. 13(a), a bold line enclosing a thumbnail represents a cursor. The user selects a thumbnail of a related program by moving the cursor across the grouping axes. FIG. 13(a) shows a state where one of a plurality of thumbnails on the performer grouping axis has been selected. When one of the related programs on the performer grouping axis has been selected with the cursor, a thumbnail of the target program at the center also represents a thumbnail of “performer” extracted from the attribute information items on the target program. In this case, the thumbnail of the related program selected with the cursor may be the same as the thumbnail of the target program at the center or a similar thumbnail may be displayed. For example, when an unaired program is set as a target program, the same thumbnail may be selected as a related program since a thumbnail of an unaired program is selected from the thumbnails accumulated in the past.

Similarly, FIG. 13(b) shows a state where one of a plurality of thumbnails on the title grouping axis has been selected. When one of the thumbnails on the title grouping axis has been selected, a thumbnail of the target program also represents a thumbnail of “title” extracted from the attribute information items on the target program.

According to the second embodiment described above, thumbnails of the related programs related to the grouping axis of the target program are arranged on a grouping axis basis. When the user has selected a thumbnail of a related program, the thumbnail is switched to a thumbnail of the same grouping axis in the target program according to the grouping axis of the selected related program, which enables the user to understand the relationship between the target program and related programs easily and select a related program easily.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A program information display apparatus comprising:
a first reading unit configured to read, from an external program information database, first program information items including bibliographic information items on programs and program accompanying information items on the programs;
a first extraction unit configured to extract, from the first program information items for each of the programs, first program attribute information items indicating first program attributes;
a second reading unit configured to read video data from an external video data database if the external video data database has the video data corresponding to at least one of the first program information items;
a second extraction unit configured to extract thumbnail images from the video data if there is the thumbnail images corresponding to each of the first program attributes at a given time of the video data;
a first accumulation unit configured to accumulate the thumbnail images associated with each of the first program attributes; and
a first control unit configured to control a display of first thumbnails and the first program information items related to the first thumbnails, each of the first thumbnails being the thumbnail images corresponding to each of the first program attributes.

2. The apparatus according to claim 1, further comprising a first selection unit configured to select the first thumbnails that specified by a user from the first accumulation unit,
wherein, each time each of the first program attributes is selected, the first control unit controls the display to change the first thumbnails corresponding to each of the selected first program attributes.

3. The apparatus according to claim 2, further comprising:
a third reading unit configured to read second program information items, the second program information items including no information in the program accompanying information items and being an unaired program information items;
a third extraction unit configured to extract, from the second program information items for each of the programs, second program attribute information items indicating second attributes; and
a second selection unit configured to, if the third extraction unit has extracted the second program attribute information items, select second thumbnails from the thumbnail images accumulated in past, each of the second thumbnails being thumbnail images corresponding to each of the second program attributes.

4. The apparatus according to claim 3, wherein the first program attribute information items and the second program attribute information items include at least one of title, performer, keyword, and genre of the program.

5. The apparatus according to claim 4, wherein, if a first program attribute and a second program attribute are the title, the second extraction unit extracts, as the thumbnail images, images included in the video data including a character string of the title, and if the first program attribute and the second program attribute are the performer or the keyword, the second extraction unit extracts, as the thumbnail images, images at a first time that located in between a second time appeared the performer or the keyword included in the video data and a third time obtained by adding the length of time during which appearance of the performer or the keyword to the second time.

6. The apparatus according to claim 1, wherein the first program information items are information of program the user is now viewing or recording.

7. The apparatus according to claim 1, wherein the program accompanying information items include at least one of caption information items, speech recognition results, and telop recognition results.

8. The apparatus according to claim 3, further comprising:
a second accumulation unit configured to accumulate the first program information items associated with the first program attribute information items, or the second program information items associated with the second program attribute information items;
a search unit configured to search the first program information items and the second program information items for third program information items on related programs and third program attribute information items that extracted from the third program information items, the related programs being related to a target program; and
a second control unit configured to classify third thumbnails related to the third program attribute information items according to the first program attributes and the second program attributes, and control a display of fourth thumbnails, the fourth thumbnails selected by the user from the third thumbnails and included in the first thumbnails or the second thumbnails.

9. The apparatus according to claim 8, wherein the second control unit performs control to group the third thumbnails on an program attribute basis, display the result in a first specific display area, select, from fifth thumbnails corresponding to the program attribute of the target program, a sixth thumbnail whose program attribute is the same as the program attribute of the fourth thumbnail each time one of the third thumbnails is selected as the fourth thumbnail, change the thumbnail to the sixth thumbnail, and display the sixth thumbnail in a second specific display area differing from the first specific display area.

10. The apparatus according to claim 8, wherein the search unit selects the target program from only the first program information items in selecting the target program.

11. A program information display method comprising:
reading, from an external program information database, first program information items including bibliographic information items on the programs and program accompanying information items on the programs;
extracting, from the first program information items for each of the programs, first program attribute information items indicating first program attributes;
reading video data from an external video data database if the external video data database has the video data item corresponding to at least one of the first program information items;
extracting thumbnail images from the video data if there is the thumbnail images corresponding to each of the first program attributes at a given time of the video data;
preparing an accumulation unit that accumulates the thumbnail images associated with each of the first program attributes; and
controlling a display of first thumbnails and the first program information items related to the first thumbnails, each of the first thumbnails being the thumbnail images corresponding to each of the first program attributes.
